(19) United States
(12) Patent Application Publication
(10) Pub. No.: US 2008/0071834 A1
(43) Pub. Date: Mar. 20, 2008

(54) Method of and System for Transferring Data Content to an Electronic Device

(76) Inventor: Jason Olen Bishop, Ovilla, TX (US)

Correspondence Address: Andre M. Szuwalski;Gardere Wynne Sewell LLP, 3000 Thanksgiving Tower, 1601 Elm Street, Dallas, TX, 75201, US

(21) Appl. No.: 11/756,540

(22) Filed: May 31, 2007

Related U.S. Application Data
(60) Provisional application No. 60/809,653, filed on May 31, 2006.
(60) Provisional application No. 60/915,959, filed on May 4, 2007.

(51) Int. Cl. G06F 17/00

(52) U.S. Cl. 707/104.1; 707/E17.009; 707/E17.101; 707/E17.019

(57) ABSTRACT

A computer readable storage medium such a DVD or CD stores media files, some of which are playable by a DVD or CD player, others of which are provided with various formats that are playable by various different media players. The computer readable storage medium also includes program instructions for instructing a computer to detect a connected media player and determine an appropriate file format for the detected media player. The user can select a media item, such as an audio or video title, for transfer to the target media file. The computer then selects the appropriate media file for the target media player and initiates transfer of the selected media file to the target media player.

### CROSS-REFERENCE TO RELATED APPLICATIONS

This application claims priority to U.S. provisional Application Ser. No. 60/809,653, filed May 31, 2006, and U.S. provisional Application Ser. No. 60/915,959, filed May 4, 2007, both of which are hereby fully incorporated by reference.

### TECHNICAL FIELD

The present invention relates generally to digital distribution systems and methods and, more particularly, but not by way of limitation, to digital distribution systems and methods for transferring data contents to media players.

### BACKGROUND

Presently, physical compact discs (CDs) and digital video discs (DVDs) sold by the entertainment industry such as, for example, music labels, publishers, movie studios, and the like contain data but fail to provide a method to transfer the data to media players such as, for example, portable media players, mobile phones, set-top boxes, or other media players. Furthermore, the data residing on the physical CDs or DVDs is not normally in an acceptable data format for the media player. As such, data conversion is required before the data can be transferred to the media player.

Many portable digital device owners are required to purchase digital media on the Internet. The device owners are required to use the software bundled specifically for their device in order to transfer the data, or use third-party software to complete the transfer. More specifically, in relation to the music industry, device owners that purchase physical music CDs are required to convert the CD-Audio content from the music CDs into an acceptable format such as, for example, MP3 format or WMA format using third-party software. After conversion, these files are transferred to portable media players or other digital devices using third-party software.

Method and apparatus disclosed herein provide improvements in distributing digital data by reducing the steps required in transferring data by using an executable stored on and running from the physical disc (CD/DVD). The executable runs from the disc, accesses all devices capable of receiving data, allows the disc owner to select a desired device, and select data content. The executable then transfers selected data residing on the physical medium (i.e., the disc) to the selected device.

### BRIEF DESCRIPTION OF THE DRAWINGS

Embodiments are illustrated by way of example in the accompanying figures, in which like reference numbers indicate similar parts, and in which:

FIG. 1 shows a block diagram of an exemplary system for transferring media content to a media player;

FIG. 2 shows a block diagram of content on the computer readable medium shown in FIG. 1;

FIGS. 3-14 show various configurations of the graphical user interface shown in FIG. 1;

FIGS. 15A-15C show embodiments of the media player shown in FIG. 1, each with a display of a digital coupon;

FIG. 16 shows a block diagram illustrating player options for an embodiment of the computer readable medium;

FIG. 17 shows a system for creating a computer readable medium such as the one shown in FIG. 1;

FIG. 18 shows an embodiment of a kiosk that allows for transferring media content to a media player;

FIG. 19 shows a flow diagram for transferring media content in a Microsoft Windows environment; and

FIG. 20 shows a flow diagram for transferring media content in an Apple iPod/iTunes environment.

### DETAILED DESCRIPTION OF THE DRAWINGS

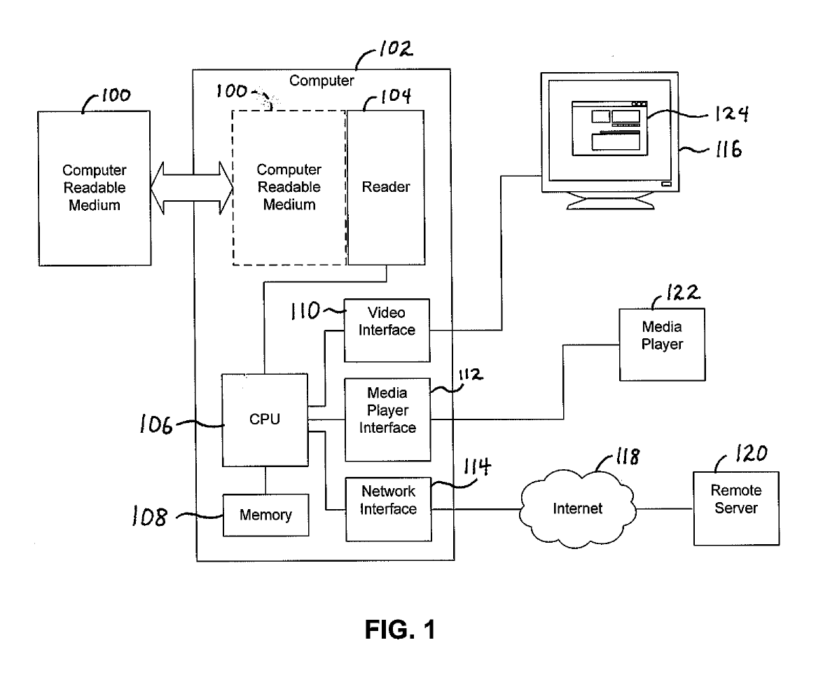

It will be readily understood that the components of the present disclosure, as generally described and illustrated in the Figures herein, could be arranged and designed in a wide variety of different configurations. Thus, the following more detailed description of the embodiments of the system and method of the present disclosure, as represented in FIGS. 1 through 20, is not intended to limit the scope of the concepts described herein.

Reference is first made to FIG. 1, which shows a computer readable medium 100 that contains computer readable content including one or more media items. Media items can include such things as movies, music, pictures, electronic books, games, and ring tones. The computer readable medium 100 can be, for example, an optical disc such as a CD, a DVD, a Blu-ray Disc, or a High-Definition DVD. Alternatively, the computer readable medium 100 can be another type of computer memory or data storage, for example a solid-state memory device such as a Flash drive.

The computer 102 can be a personal computer, laptop, workstation, or the like that includes a reader 104 suitable for reading data stored on the computer readable medium 100. For example, in embodiments where the computer readable medium 100 is a CD or a DVD, the reader 104 can include a CD/DVD drive. The computer 102 also includes a central processing unit (CPU) 106 and memory 108. The memory 108 can include a combination of different types of storage, for example random access memory (RAM) and an optical hard drive. The reader 104 operates under the control of the CPU 106. The CPU 106 also controls other components of the computer 102, including a video interface 110, a media player interface 112, and a network interface 114. The video interface 110 provides video output for a monitor 116, and the network interface 114 allows the computer 102 to communicate with a remote server 120 across a network, for example across the Internet 118.

The media player interface 112 allows for interaction between the computer 102 and a media player 122. The media player interface 112 can include a serial bus, for example a Universal Serial Bus (USB). The media player interface 112 can also include a transmitter for wireless communications with a media player, for example using the Bluetooth industrial specification developed and licensed by the Bluetooth Special Interest Group (SIG). The media player 122 can include such things as portable digital audio and/or video players, mobile phones, and video game consoles.

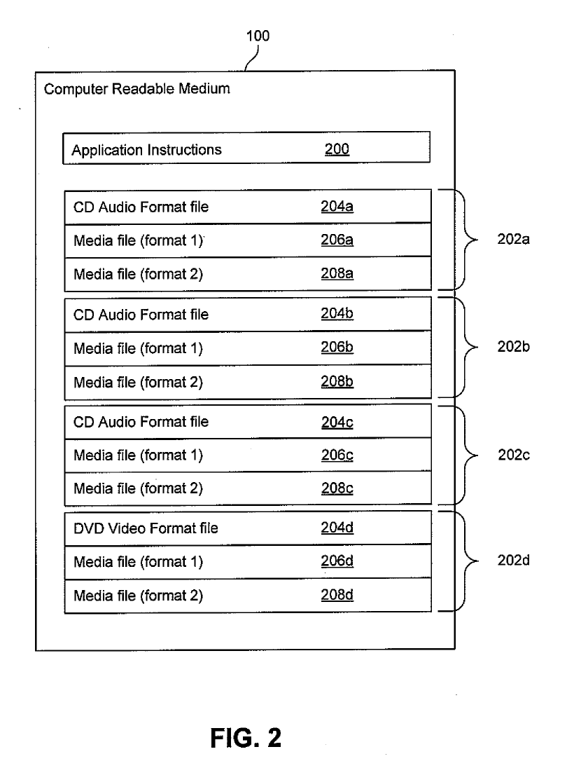

Referring now also to FIG. 2, the computer readable medium 100 includes program instructions 200 that are executable by the computer 102. The computer readable medium 100 also includes a number of media items 202. In FIG. 2, for example, the computer readable medium 100 includes media items 202a, 202b, 202c, and 202d, where media items 202a-202c are audio selections, for example audio tracks of a movie soundtrack, and media item 202d is a video presentation, for example a movie. The program instructions 200 include instructions which are executed by the computer 102 when the computer readable medium 100 is received by the reader 104 for generating a graphical user interface (GUI) 124 on the monitor 116. The GUI 124 (in accordance with the program instructions 200) allows a user to interact with the computer readable medium 100, including allowing a user to populate the media player 122 with one or more media files 206, 208 from the computer readable medium 100. In some embodiments, the GUI 124 can also display media items available from the remote server 120. In some embodiments, the user can select one or more media items 202 for transfer to the media player 122. The program instructions 200 include instructions for the computer 100 to detect the media player 122, or at least the appropriate file type for the media player 122, and then transfer the appropriate media file to the media player 122. For example, a user may desire a particular song from a soundtrack stored on the computer readable medium 100, where the song is media item 202a, which is stored in a number of different formats 204a, 206a, and 208a. The computer 100 detects that the media player 122 can play the format of the music file 206a, so the music file 206a is transferred to the media player 122. Note that while only a few file formats are shown for each media item 202, in actual implementations a greater or fewer number of file formats can be stored for each media item 202. Also, in alternative embodiments, the program instructions 200 can include instructions for converting a stored file format into a different format that is appropriate for the media player 122.

Data stored on the computer readable medium 100 can include:
Standard CD audio format files and/or files of any other standard for audio content and/or files formatted according to DVD data standards for movie content;
installation files for installing the application (instructions 200) on the computer 102 and an installation application that executes the install;
audio content in one or more different formats that can be read and written to the portable media player 122;
a computer executable file that contains a content processing application (instructions 200);
images and other files that are used by the content processing application (instructions 200) operating as the interface between the physical medium and the portable media player, i.e. graphics, buttons, advertisements, etc.; and
encryption components for preventing unauthorized media transfers, for example transfers of media that must first be purchased.

The program instructions 200 can include instructions for a software application that launches from the computer readable medium 100 or the remote server 120 and displays the GUI 124. In some embodiments, it may be preferable for certain components of the software application to be installed on the computer 102. For example, in some embodiments, it is preferable for the user to install Microsoft Windows Media Format, a Microsoft Windows based Component Object that supports Windows based products (PlayForSure), and iTunes Component Object which supports iTunes related products (iPod). Once the components are installed, the user can be instructed by the GUI to select a product category for media files that will be transferred to a media player. The product category may be, for example, a Windows supported product (PlayForSure) or an iTunes supported product.

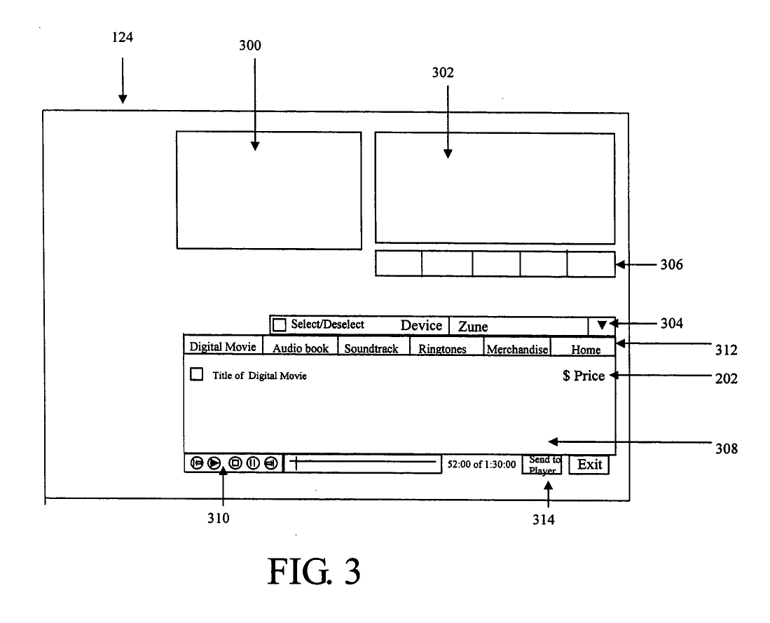

Referring next to FIG. 3, an embodiment of a computer-generated display is shown that serves as one form of the GUI 124. In the illustrated display, the GUI 124 includes an art display window 300 for displaying desired art or titles. The GUI 124 also includes a preview pane window 302 for display of and interaction with any content, for example a preview of desired video media content, text, interactive web, or the like. A device detection window 304 will display information about a detected portable media player 122. The device detection window displays information that allows a user to choose from among several media players 122 if more than one is detected. The media player 122 that appears in this window is the same device with which the software application interacts. A set of preview pane control buttons 306 allows the user to interact with content in the preview pane 302. An interactive display window 308 displays content such as the title or titles of media items 202 and pricing of the media items 202 if there is a price for the respective media item 202. The interactive display window 308 can also allow a user to select or click on a media item for launching or previewing a media item 202. A user can also launch or preview media items 202 by using a set of media player controls 310. The media player controls 310 can include controls for controlling media playback, including functions such as play, pause, stop, rewind, fast-forward, previous track, and forward track. Thus, once a media item 202 is selected by the user, the user can control that media with the buttons displayed in the media player controls 310.

The display shown in FIG. 3 also includes a set of content tabs 312 which allow the user to browse and navigate through multiple types or categories of media items 202 stored on the computer readable medium 100. Content tabs 312 can also allow the user to navigate and interact with content provided from one or more remote servers 120. Examples of categories can include categories related to movies, audiobooks, audio tracks (e.g., albums, music, and soundtracks), ringtones, and other merchandise.

Finally, a “Send to Player” control 314 is provided for initiating the process of transferring a media file associated with a selected media item 202 to the media player 122. Predetermined content can be sampled and purchased directly from the GUI 124. If the predetermined content is offered at no charge to the consumer by the request of the content owner/provider, the user can simply select or “click” (i.e., move the cursor to the control 314 image and press a mouse button) on the “Send to Player” control 314, and in response the computer 100, following the application instructions 200, will detect the attached media player 122 and transfer the appropriate media file 206 or 208 (whichever is in the appropriate format for the user's media player 122) associated with the selected media item 202 to the media player 122. If the selected media item is not free, but rather is sold through the GUI 124, then after the user selects or clicks on the “Send to Player” control 314, the computer 100, following the application instructions 200, will pull a secure online e-commerce form into the GUI 124. The user can then enter the standard personal information associated with e-commerce, and once the transaction has been approved the e-commerce server will authorize the purchase. A key will be generated by a remote server 120 and will be issued to the computer 100 for unlocking the selected media item 202 and allowing for transfer to the media player 122. The computer 100, following the application instructions 200, will then transfer the appropriate media file 206 or 208 (whichever is in the appropriate format for the user's media player 122) associated with the selected media item 202 to the media player 122.

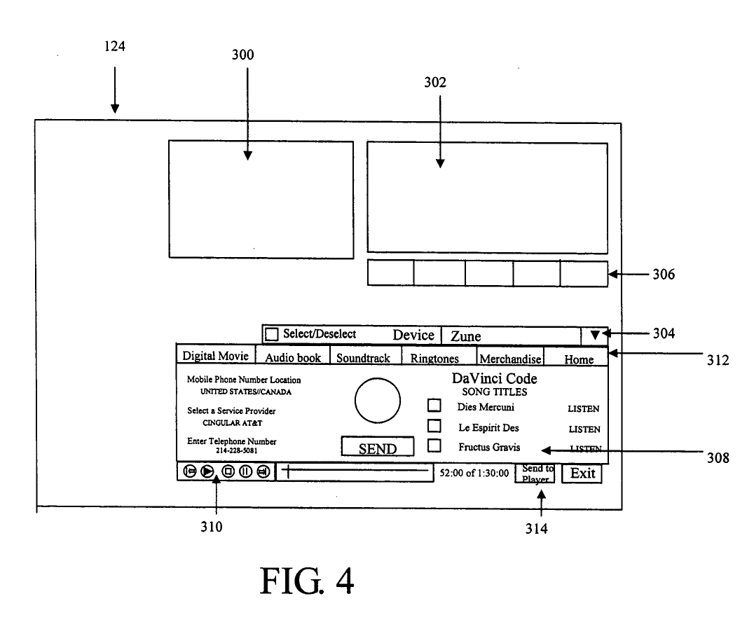

Referring to the GUI shown in FIG. 4, in some embodiments, for example where the selected media item 202 is a ringtone and/or the media player 122 is a mobile telephone, after the user selects or clicks on the “Send to Player” control 314 and completes any e-commerce steps if the selected item must be purchased, the user is prompted to enter information about the mobile phone, for example service provider and mobile phone number, and the media file 206/208 can then be sent to directly to the mobile phone by means of a conventional messaging service, for example a short message service (SMS) or an Internet download link. If there is a cost associated with the selected media item 202, the charges can be billed directly to the user's mobile phone as a charge or can be accounted for by means of a third party billing service.

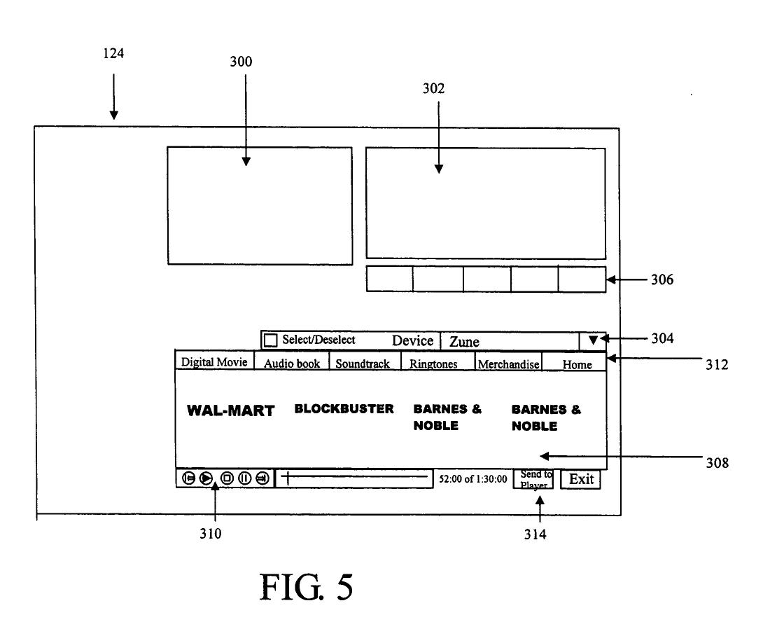

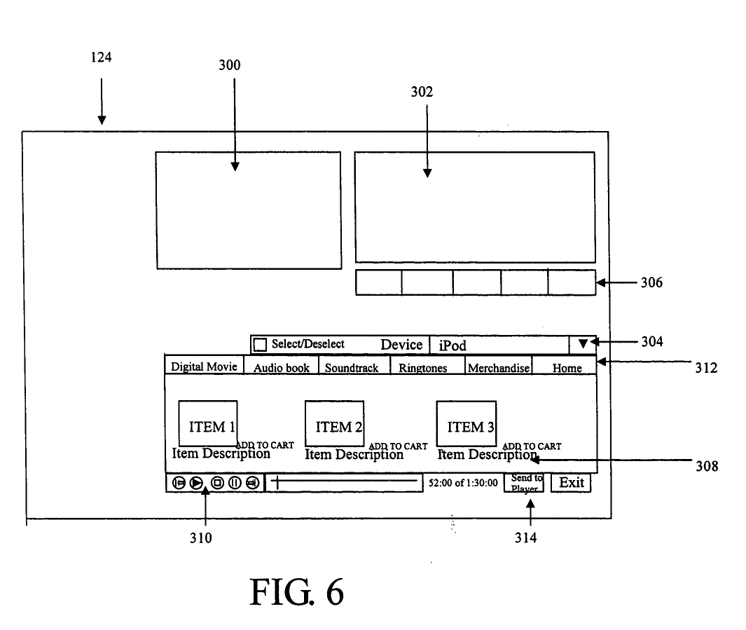

Referring next to FIGS. 5 and 6, as mentioned above the content tabs 312 can include a “merchandise” tab or the like. When the user selects the merchandise tab, the interactive display window 308 provides a display of a virtual merchandise store that includes icons 314 that link to one or more online retailers. Merchandise is made available for sale, preferably including merchandise that is related to other content stored on the computer readable medium 100. For example, if the computer readable medium 100 is a DVD that contains or relates to a particular movie, merchandise may include ring tones, board games, PC games, clothing, or other merchandise related to the movie. Note that the online retailers can include retailers that track the source of sales, and so sales coming from the computer readable medium 100 can be tagged allowing them to be tracked. This allows for collection of a commission on all transactions executed through that computer readable medium 100.

The merchandise tab allows an end user to browse to a shopping display as shown in FIGS. 5 and 6. In FIG. 5, icons are displayed for a number of retailers. Once the user selects a retailer, a display such as shown in FIG. 6 is presented that includes images or links for buying merchandise from the selected retailer. The user can then select from among one or more icons linked to merchants that have that merchandise for sale.

A business method associated with the merchandise tab includes collecting placement fees from retailers in exchange for placement on the computer readable medium 100 in the virtual store front. The business method also includes collecting a commission for sales of anything sold through the virtual store front. The sales through the computer readable medium 100 can be tracked, allowing for collection of a commission on all transactions executed through that computer readable medium 100. The virtual storefronts can be changed dynamically any given time, for example the retail stores can be changed monthly or even daily. The business method can include collecting multiple retailer placement fees and storefront fees on a per placement-period basis, e.g., daily or monthly basis. Example: Month 1 the GUI 124 includes links that allow a consumer to make purchases from Wal-Mart, Blockbuster, Barnes and Noble, and Audible; then Month 2 the GUI 124 includes links that allow a consumer to make purchases from Circuit City, Cosco, iTunes, Comp USA, and Netflix. So, for example, the business method can include collecting store placement fees every month on the same computer readable medium 100.

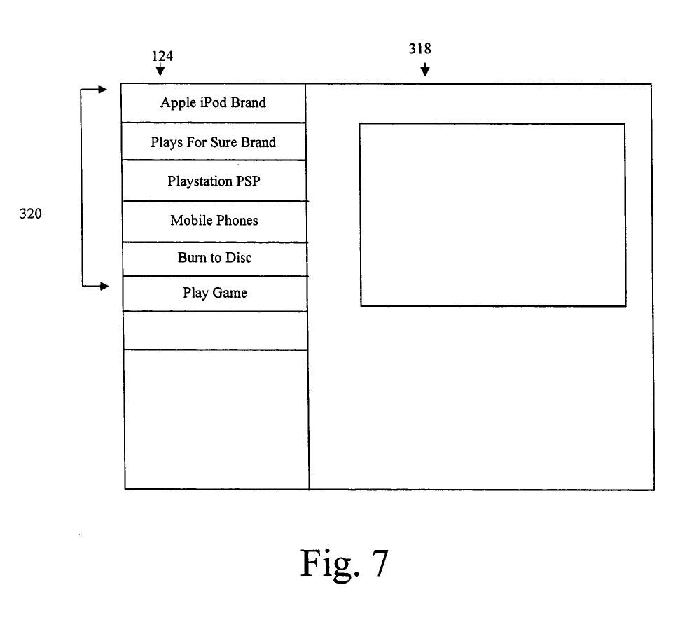

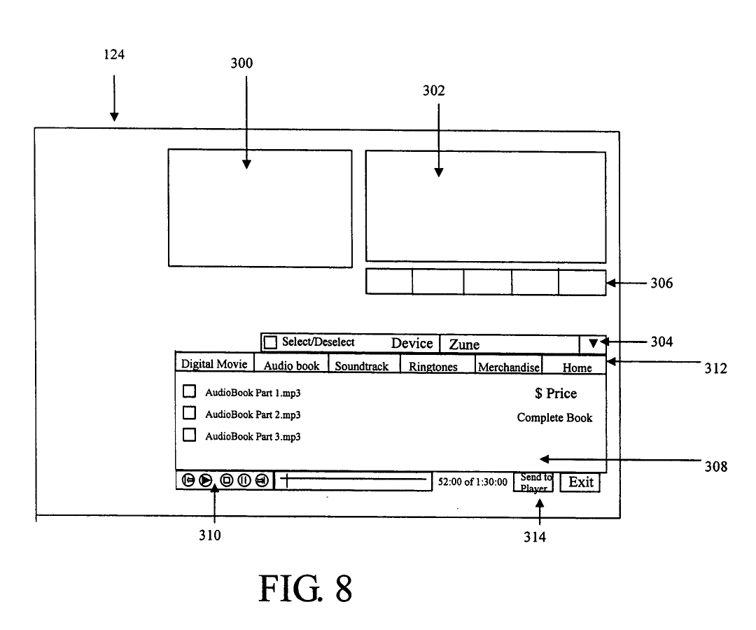

Referring next to FIG. 7, the GUI 124 can include an optional menu screen 318 that includes a menu 320 of options for the user. In some embodiments, the option menu 320 can include a “burn disc” option or the like. A user can select the “burn disc” option to transfer media files directly onto a target writable disc, such as a CD-R/DVD-R/DVD+R/DVD-R Dual Layer, DVD+R Dual Layer, BlueRay, BlueRay Dual Layer, HD DVD disc, or other computer readable medium. FIG. 8 shows the GUI 124 that is presented after a user selects the “burn disc” option. From within the interactive display window 308, the user can select one or more files for transfer onto a disc, then click on the “Send to Player” control 314. In some embodiments, for example where the computer readable medium 100 is a CD or DVD, it the reader 104 may also serve as a writer for writing the content onto the target disc. In such cases, the computer readable medium 100 may need to be removed so that the reader 104 can write the data file(s) to the target disc. In such cases, the application instructions 200 include instructions for creating an .iso image of the computer readable medium 100, or at least the portions to be written to the target disc, and then the computer readable medium 100 will eject itself or otherwise allow for its removal. The user will then be prompted to insert the target disc. The copy will then be burned onto the target disc.

The application can also use embedded burning features to allow the content owner/provider to offer to the user an option to purchase the original content on demand. For example, if the computer readable medium 100 is a DVD, the user can have the option of purchasing a complete clone of the DVD. With this unique cloning model, a retail disc can for the first time become its very own physical and digital distribution outlet. By also placing the application 200 onto the cloned copy, this enables that cloned disc to be its own retail outlet for further potential sales by means of consumer to consumer marketing. The application 200 supports opening and executing e-commerce facilities in support of each additional cloned sale. Note that in some embodiments, the cloned copy can include the ability to make a next generation of cloned copies, while in other embodiments, the cloned copy is prohibited from making further cloned copies.

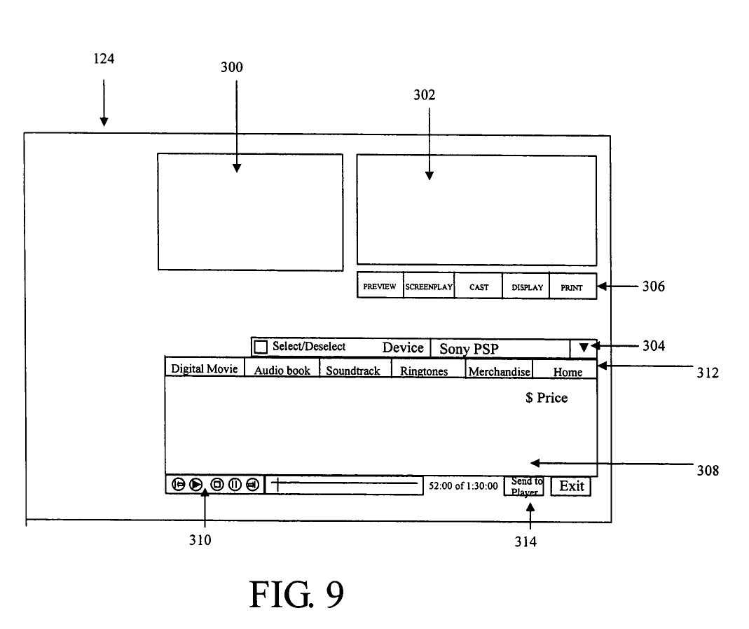

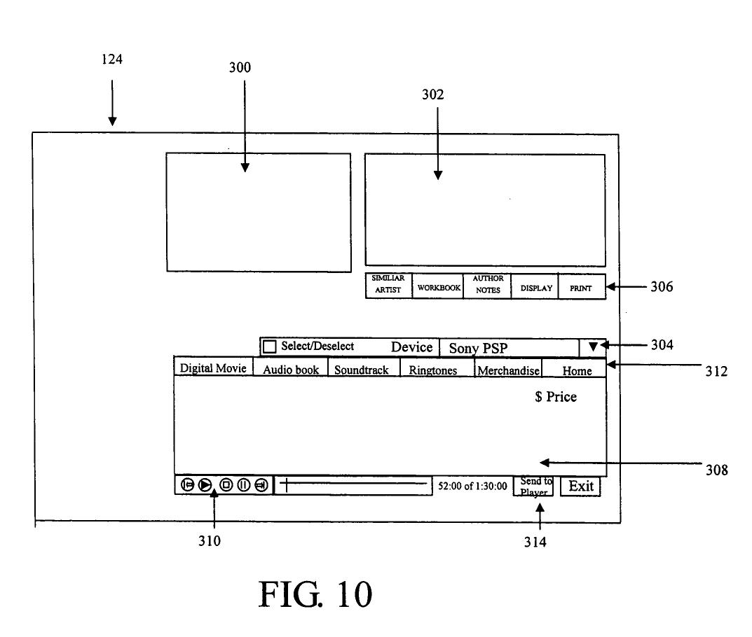

Referring next to FIG. 9, the title or verbiage on each button of the preview pane control buttons 306 can change dynamically according to which content tab 312 is chosen by the user. For example, as shown in FIG. 9, the user has selected the “digital video” content tab 312, which causes the preview pane buttons 306 to have the following button set titles and links: “Preview,” “ScreenPlay,” “Cast,” “Display,” and “Print.” If the user then selects the “Audiobook” content tab 312, the display shown in FIG. 10 is presented where the preview pane buttons 306 have changed to have the following button set titles and links: “Similar Artists,” “Workbooks,” “Authors Notes,” “Display,” and “Print.”

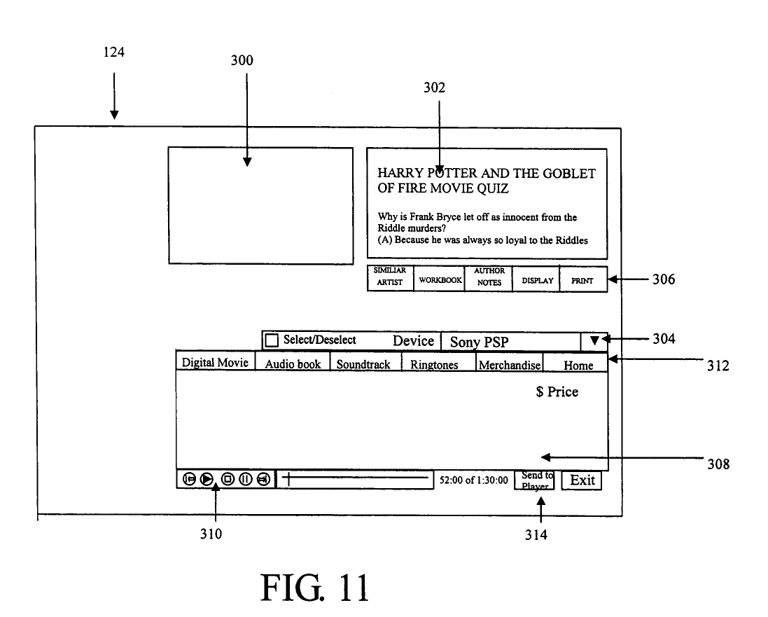

FIG. 11 shows the GUI 124 if the “workbook” button 306 is selected. The preview pane window 302 now displays an appropriate electronic workbook (i.e., electronic book of problems or questions related to the contents of the audiobook) associated with the audiobook previously selected in the interactive display window 308. If the “workbook” button 306 is selected, and then the “Display” button 306 is pressed, the content within the interactive display window 308 will be displayed in a larger, separate window or in a “fall screen” view, which allows the user to more easily interact with the displayed content. If the “workbook” button 306 is selected, and then the “Print” button 306 is pressed, the user's default printer will be detected and the content within the display window 308 will be printed.

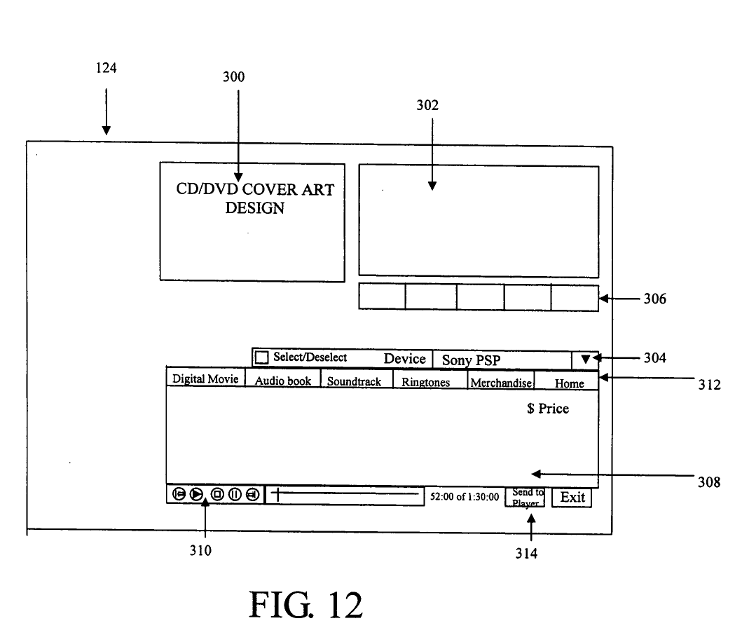

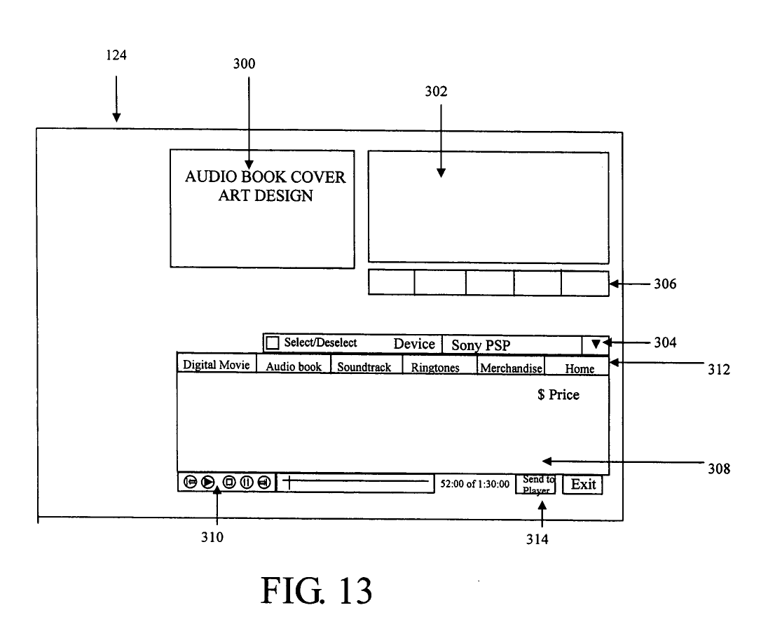

Turning next to FIGS. 12 and 13, the image displayed in the art display window 300 can change dynamically according to which content tab 312 is chosen by the user. For example, as shown in FIG. 12, the user has selected the “digital video” content tab 312, which causes the art display window 300 to display the cover art of the content that relates to the digital video content (media item 202) being offered for purchase and/or for transfer to the media player 122. If the user then selects the “Audiobook” content tab 312, the display shown in FIG. 13 is presented where the art display window 300 has changed to display the cover art of the content that relates to the digital audiobook content (media item 202) being offered for purchase and/or for transfer to the media player 122.

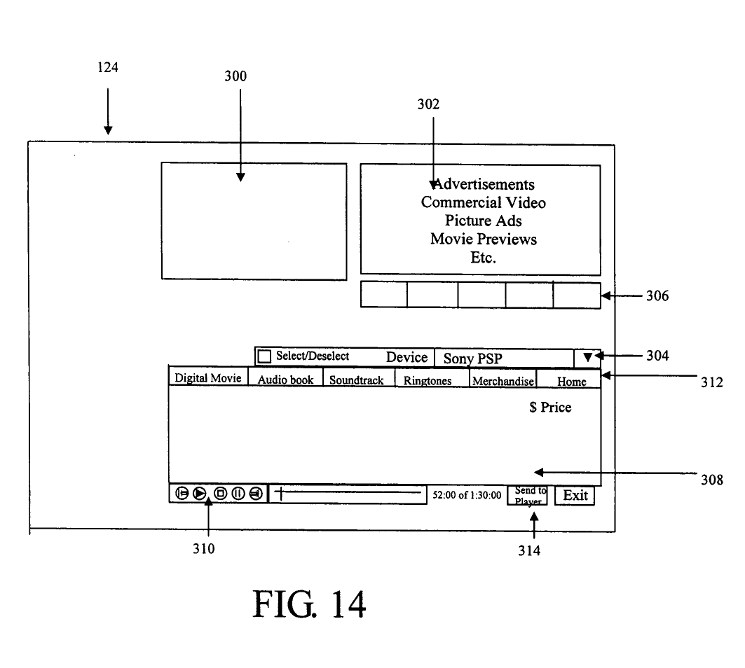

Referring next to FIG. 14, in some embodiments the preview pane window 302 displays commercial advertising, for example in the form of a video advertisement, during data transfer of a media file 204, 206 to the media player 122 or other target medium. In some embodiments, the advertising can also be manually launched by the user even when there is no data transfer. The commercial video can be pre-encoded and resident on the computer readable medium 100, or can be retrieved from a remote server 120, which allows video advertising content to be updated or changed. In some embodiments, the commercial video advertising must be launched and played in its entirety before media content transfer to portable device is allowed to begin or allowed to be completed.

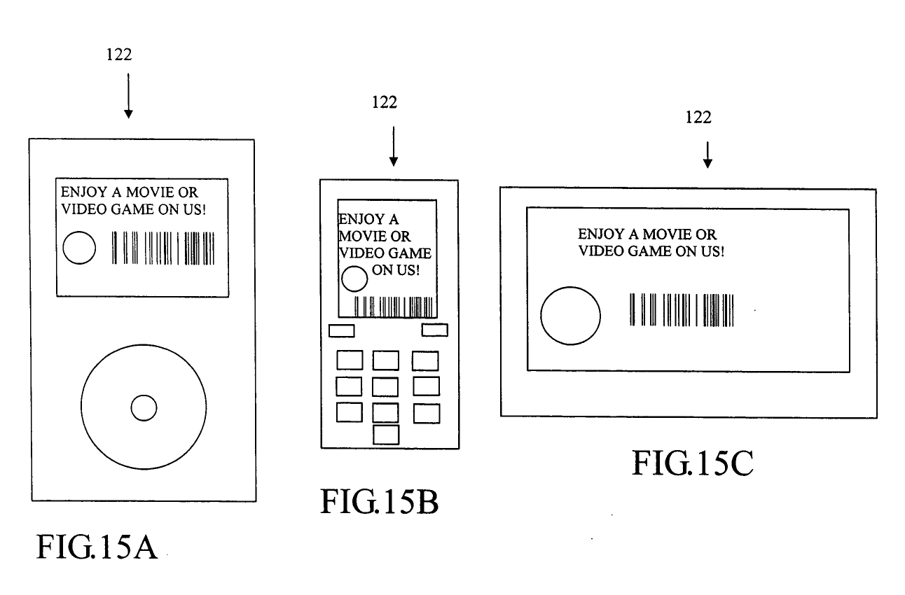

Referring next to FIGS. 15A-15C, the application 200 can cause coupons to be viewed in the interactive display window 308 of the GUI 124 and transferred to a media player 122. FIGS. 15A-15C show various examples of different types of media players 122 each displaying a coupon. FIGS. 15A and 15C show different styles of portable audio/video players that can serve as examples of media players 122, and FIG. 15B shows a mobile telephone having audio and video playback capabilities that can also serve as an example of a media player 122. The coupons can be stored on the computer readable medium 100 or transferred from the remote server 120 as image files. The coupon image files can then be transferred to the media player 122 via the media player interface 112. The coupon image can then be viewed on the media player 122 as shown in FIGS. 15A-15C, and the displayed coupon image can be scanned at a local retail store that is referenced in the coupon's details. In some embodiments, one or more digital coupons can be sent automatically along with the selected media items 202 to the media player. Such embodiments can allow content owners that choose to give away the media items at no cost to the user an opportunity to receive a partial return on the no-cost digital content.

In some embodiments, each digital coupon that is transferred via the application can be accounted for by a central remote server 120. The digital coupons can be pre-encoded, reside on the computer-readable medium, and/or can be retrieved from a remote server 120. Thus, digital coupons can reside on a remote server so that they may be updated or changed. Coupons, once on the media player 122, can be displayed as an image with a unique barcode that can be processed and scanned by a point of sale system.

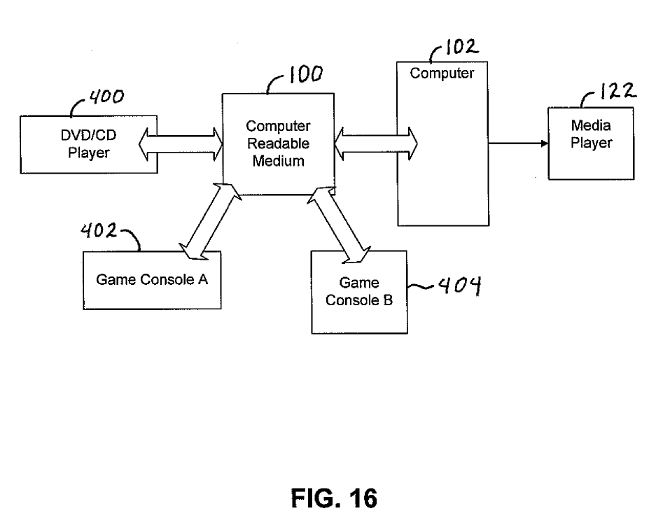

Referring next to FIG. 16, in a preferred embodiment the computer readable medium 100 includes data that can be read by a computer 102, which in turn can transfer media files 206, 208 to a media player 122 according to application instructions 200 that are also provided on the computer readable medium 100. The computer readable medium 100 can be a DVD or a CD that also contains one or more DVD video format files 204d (shown in FIG. 2) and/or one or more CD audio format files 204a-204c (shown in FIG. 2), so the computer readable medium 100 can be played by a DVD/CD player 400. In some embodiments, the computer readable medium 100 can further include media gaming files for a complete, sample, partial, or preview video console game, preferably related to other content on the DVD or CD. Each media gaming file can be for the same game, but can have a different format such that each file is playable on a different game console. For example, the computer readable medium 100 shown in FIG. 16 can include a video game file in a first file format that is playable by Game Console A 402, and the same, or substantially the same video game file in a second file format that is playable by Game Console B 404. Thus, the user can play the DVD/Demo Game combination on multiple gaming platforms.

According to some embodiments, the application is capable of decrypting an encrypted media file 206, 208 during the process of transferring the media file 206, 208 from the computer readable medium 100 to the media player 122 while bypassing the computer's hard drive/storage. In some embodiments, predetermined content is placed into encrypted folders that can only be unlocked with a product key, which is provided by the remote server 120 and sent to the computer 102 upon the completed e-commerce purchase of corresponding media items 202 or media files 206, 208. In alternative embodiments, the user will be prompted to enter a product key manually that will unlock the chosen media items 202 or media files 206, 208. The encrypted media files can then be decrypted and transferred instantly and directly to the media player 122. Also, the content that is purchased is can be logged and tracked by the remote server 120, for example in order to allow the content, once purchased, to be transferred to a limited number of media players 122, where the limited number can be predetermined by the content owner. According to some embodiments where the user is required to watch a commercial advertisement as discussed above in connection with FIG. 14, a specific commercial or set of commercials can be associated with the purchased media item, the remote server can be notified each time the associated commercial plays, and the number of times the purchased media item has been transferred can be tracked by the remote server 120 based on the number of times the associated commercial has played. For example, if the predetermined transfer limit is three media players 122 per one purchase of the computer readable medium 100, then the user will purchase the offered content one time, and then after that content reaches its maximum transfer limit of three transfers, the Application will prompt the user to re-purchase the content before transferring the content to any additional media players.

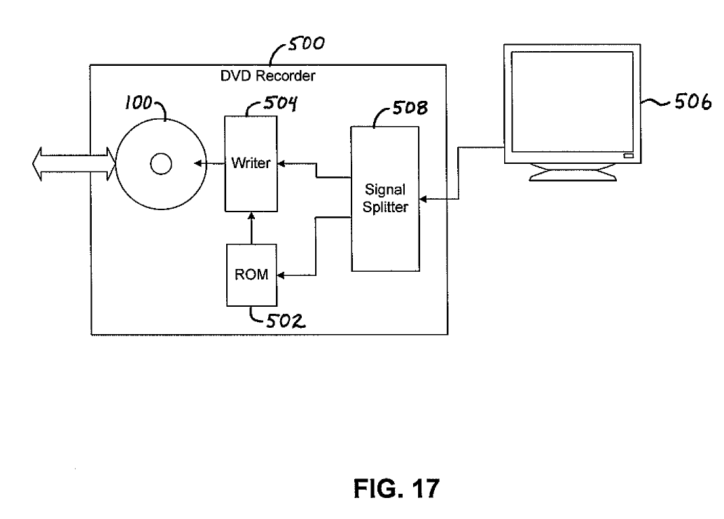

Referring next to FIG. 17, a DVD recorder 500 can be used to create a computer readable medium 100, which in this embodiment is a DVD. It will be appreciated that these concepts can be readily applied to many types of recording devices, for example those used to write to a CD-R/DVD-R/DVD+R/DVD-R Dual Layer, DVD+R Dual Layer, BlueRay, BlueRay Dual Layer, HD DVD disc, or other computer readable medium. By placing the application instructions 200 (shown in FIG. 2) onto a read-only memory device (ROM) 502, for example a silicon chip, a Standalone Home DVD Recorder or the like will have the ability to create an computer readable medium 100 on demand. The content being recorded will populate file structures within the ROM 502 along with the application instructions 200, which will then in turn be provided to a writer 504, which will write the media files and application instructions to the DVD 100.

The DVD recorder 500 receives content to be recorded from a television 506 or other media source. The recorder 500 includes a signal splitter 508 which provides the content to the writer 504 and also provides the content to the ROM 502. The content provided to the writer 504 from the splitter 508 can be recorded to the DVD according to conventional processes and protocols using the writer 504. The content provided to the ROM 502 is processed by the ROM 502, which includes encoding the content in one or more media files each having a different format (e.g., .mp4, .wma, etc). The encoded media files, along with the application instructions, are then provided from the ROM 502 to the writer 504, which in turn writes the files and application instructions to the DVD 100.

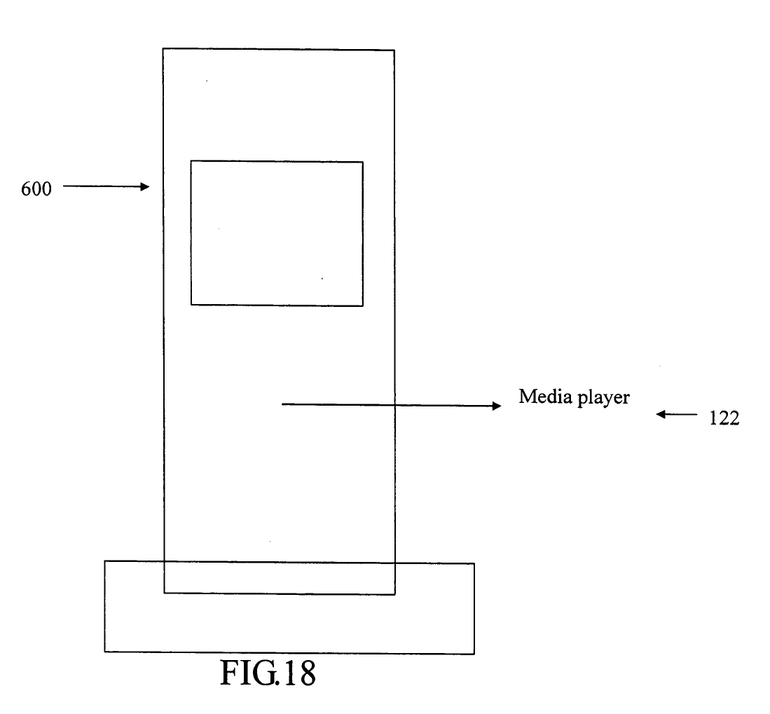

Turning next to FIG. 18, by placing the application instructions 200 onto a silicon chip or onto a hard drive as an application in an interactive kiosk 600, the resulting kiosk 600 will provide the ability to index content and use the GUI 124 along with its universal transfer method and include a comprehensive audio/video cataloging system to deliver digital content relating to any given title in the video/audio catalog. A user chooses a movie/video or audio file from the catalog of pre-encoded titles located on the kiosk's storage space, for example a hard drive. The user is presented with the standard GUI 124 containing the digital media requested as well as offering other related digital content from within the same interface. The user selects the digital content which they would like to purchase and choose the appropriate payment type, for example credit card, cash notes, etc. Once the transaction is approved, the user will be prompted by the GUI 124 to connect, wired or wirelessly as appropriate, the user's media player 122. The application will detect the media player 122 and securely deliver the selected media file or files directly to the media player 122.

Specific embodiments will now be described for typical embodiments, first where the user is operating in a Microsoft Windows environment, then when a user is operating in an Apple iPod/iTunes environment.

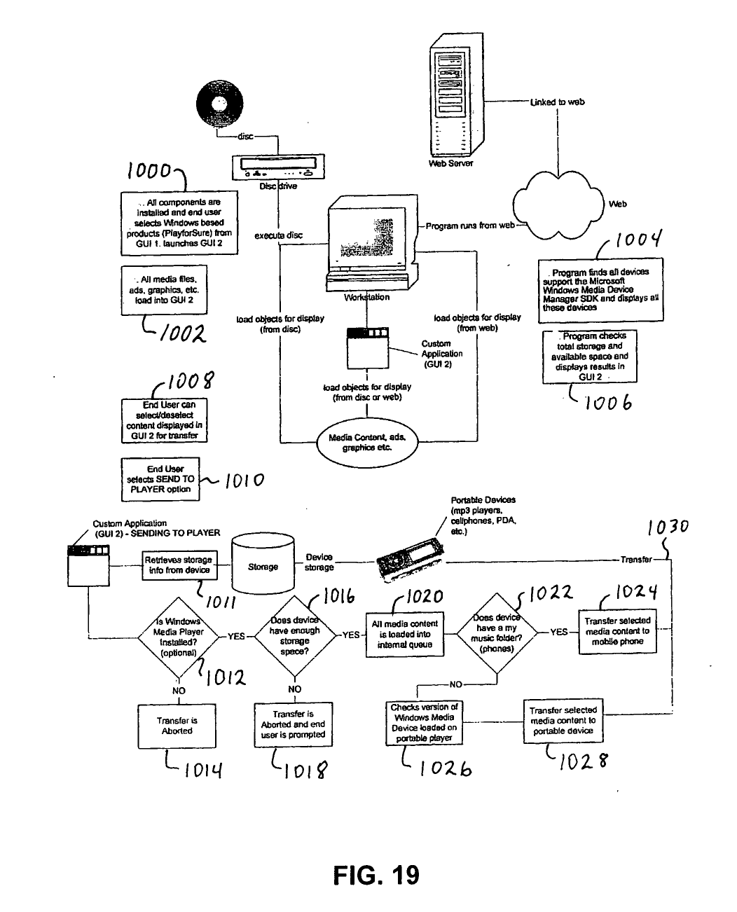

Windows Supported Products—PlayForSure: Referring to the flow diagram shown in FIG. 19, users selecting the Windows supported option will cause the program to close the initial Graphical User Interface (GUI) activating a new GUI interface (step 1000). Upon GUI activation, the media files such as, for example, video content, audio content, and the like will load based on the files located in the Media Directory to the appropriate location on the GUI (step 1002). These files are in list view and contain checkboxes that may be selected or deselected for indicating transfer to the portable media player. According to embodiments, contents listed in the transfer list area are available for transfer to the portable media player. All other components are viewable and manipulated from the computer/processor only.

In conjunction to the previous step, all advertisements are loaded from the Media Directory for display on the GUI. Also, any other data will be loaded at this time, which may include, for example, liner notes, screen plays, or any other relevant documentation related to the content.

Concurrently to loading the media files, the program looks for all the portable media players attached to the computer/processor that support the Microsoft Windows Media Device Manager (SDK) and displays all these devices in a dropdown menu available for selection (step 1004). Using the Windows Media Device Manager (SDK) the application retrieves the total storage capacity and available free space of the device selected in the drop down menu (step 1006).

The steps involved in sending transferable data to the portable media player are as follows:

The default application pre-selects all media available for transfer. The end user may de-select any tracks/content in order to eliminate it from the transfer to portable device (step 1008). Once the send button is clicked (step 1010), the application uses the Windows Media Device Manager SDK in order to retrieve storage information (step 1011) from the portable device (media player 122) and thereby determine whether the portable media player contains the Windows Media Player engine (step 1012). If the portable media player does not support this engine and the option is not disabled, the transfer is aborted (step 1014). The next step involves determining whether there is enough space on the portable media player to complete the full transfer (step 1016). If the transfer is aborted an error message will prompt the end user (step 1018). If the device selected satisfies (no errors or exceptions) the application then in step 1020 all the files selected for transfer are loaded into an internal queue using one of the two options (note: all steps are capable of bypassing the hard-drive on the supporting computer/workstation).

Option 1: files are pre-encoded and mastered in the Media Directory and are in an acceptable data format from the CD/DVD medium for transfer to portable devices (i.e. MP3, etc.);

Option 2: files are not pre-encoded and the application itself converts/rips the standard data content into an acceptable data format on the fly (i.e. CD Audio to MP3, etc.);

Both options may include an encryption scheme that is decrypted using the software and data residing on the physical disc, thus preventing file sharing. (note: encryption scheme—if disc is not in disc drive then content may not be removed using the software). The application looks in step 1022 for a folder on the portable media player called My Music (note: this step is specifically for phones). If the folder is detected, the application dumps all the content for transfer to the phone (step 1024). However, if no folder is detected, the application checks the version of the Windows Media Device loaded on the portable media player (step 1026). Based on which version is returned the content is transferred to portable media player in the acceptable way that matches the version (step 1028). Once the transfer 1030 is complete, the application prompts the end-user and the application terminates.

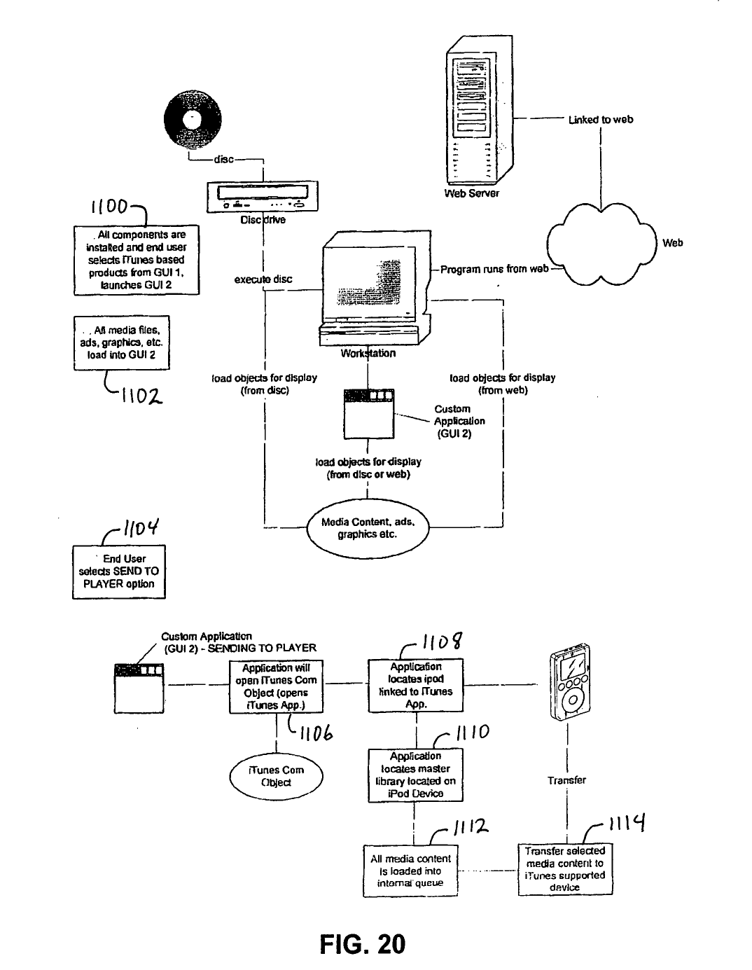

iTunes Supported Products (iPod): Referring next to FIG. 20, a user selecting the iTunes supported option will cause the program to close the initial graphical user interface and a new GUI will activate (step 1100). Upon GUI activation, the media files (video content, audio content, etc.) will load based on the files located in the Media Directory to the appropriate location on the GUI (step 1102). These files are in list view and contain checkboxes that may be selected or deselected for transfer to the portable media player. According to embodiments of the present invention, only content listed in the transfer list area will be available for transfer to portable media player. All other components are viewable and manipulated from the computer/processor only.

In conjunction to the previous step, all advertisements are loaded from the Media Directory for display on the GUI. Also, any other data would also be loaded at this time, which may include, for example, liner notes, screen plays, or any other relevant documentation related to the content. Concurrently to loading the media files, the program will load the iPod device in the portable device drop down menu.

The steps involved in sending transferable data to the iPod device are as follows:

The user selects the “send to player” option (step 1104). The application opens the iTunes COM object, which opens the standard iTunes application (step 1106). The application finds the iPod that is linked to the iTunes application, which is also the iPod displayed in the portable media player drop down menu of the custom GUI (step 1108). The default application will pre-select all media available for transfer. The end user may de-select any tracks/content in order to eliminate it from the transfer to the portable media player. The application locates the master library located on the iPod device (step 1110). If the device selected satisfies the application, then all the files selected for transfer are loaded into an internal queue (note: all steps are capable of bypassing hard-drive on the computer/workstation) in step 1112 using one of the two options:

Option 1: files are pre-encoded and mastered in the Media Directory and are in an acceptable data format from the CD/DVD medium for transfer to portable devices (i.e. MP3, etc.);

Option 2: files are not pre-encoded and the application itself converts/rips the standard data content into an acceptable data format (i.e. CD Audio to MP3, etc.);

Both options may include an encryption scheme that is decrypted using the software and data residing on the physical disc, preventing file sharing. (note: encryption scheme—if disc is not in disc drive then content may not be removed using the software). Finally, the content is transferred, in step 1114, to the iPod using iTunes to channel the media to the iPod device. Once the transfer is complete, the application prompts the end-user and the application terminates.

Referring back to FIG. 1, embodiments of the illustrated system can include one or more processors in the CPU 106. Embodiments can also combine or distribute illustrated components in any number of devices or apparatus. For example, a media player 122 can include a content processing system (reader 104 and CPU 106) for a computer readable medium 100 (i.e. CDs, DVDs, HD, Blue Ray etc.), including a data processing application (instructions 200) capable of reading/writing data from the computer readable medium 100 to the media player 122. The media player 122 may be, for example, any device that is capable of running an application. Such an embodiment can further includes an interface configured to interface the data processing application (instructions 200) with the computer readable medium 100 and to interface the data processing application (instructions 200) with the media player 122. The data processing application can include software drivers configured to control the media player via the interface. The data processing application capabilities can be stored locally on the computer readable medium 100 and installed to a processor for execution, installation set to auto-run.

According to an alternative embodiment, the data processing application instructions 200 capabilities may be stored and executed locally on the computer readable medium 100 only, via processor and an application set to auto-run.

The data processing application instructions 200 can instruct a processor to read data from the computer readable medium 100 and display the data via a display. The data processing application instructions 200 can instruct a processor to retrieve and display all connected media players 122 capable of having data written to their respective storage areas via the interface. The data content are displayed file by file based on the computer readable medium's (100) specifications (meta data) and may be selected or deselected for transfer to the media player 122 via the interface.

According to embodiments, the system is adapted to read and manage data contents residing on the displayed media player 122 via the interface and is further adapted to delete/remove data that is on the media player 122.

Data transfer starts after the data processing application checks for adequate storage capacity on selected media player 122 via the interface. The data processing application uses the media player 122 specifications to determine how and where the data files will reside in the media player's (122) respective storage area. The data transfer is also processed using third-party COM objects to complete the content transfer to the media player 122. The data processing application is capable of transferring data from computer readable medium 100 directly to detachable media players 122, bypassing the processor's hard drive/storage.

According to an alternative embodiment, the data processing application is capable of converting files to different formats on the fly during processing from the computer readable medium 100 and transferring to the media player 122 bypassing the processor's hard drive/storage.

According to an alternate embodiment, the data processing application is capable of acquiring and applying digital rights management to a file on the fly during processing from the computer readable medium 100 and transferring to the media player 122 bypassing the processor's hard drive/storage.

According to yet another embodiment, the processing application (Custom Interface) is capable of the following regarding ring tones:
Ring tones are pre-encoded, reside on a physical medium and are transferable to a portable media device (i.e. mobile phone) via a custom application
Processing application has custom ring tone capabilities, allowing end user to encode ring tones from the disc (physical medium) using user-friendly custom application and transfer to portable device
Ring tones may be retrieved online, via the internet, using custom application and transferred to portable device.

According to yet another embodiment the processing application (instructions 200) is capable of the following regarding computer/console games:
Computer Games resides on recording medium (disc) along with other media content (music, audiobook, ring tones, console games, or movie) that launches from custom application on demand
Computer Games may be retrieved online, via the internet, using custom application on demand in conjunction with all other application capabilities (music, audiobook, ring tones, console games, or movie).

The software application is preferably embedded onto a master copy of a CD or DVD during the manufacturing/stamping process. The software application enables content to be transferred to wireless devices more rapidly and efficiently than prior methods. While these transfers occur, content owners may utilize an additional advertising feature to either promote their own products or allow third parties to pay to reach targeted audiences.

Advantages include increased transfer speed, broad-based compatibility, richer media, advertising opportunities, and restored value to discs (CDs/DVDs). The software application allows for transfer of a full length movie from the disc to any compatible wireless device in less than three minutes. This will allow wireless devices, e.g., video iPods, video-enabled phones, and similar devices to be used more than ever and allow people to take content with them wherever they want. Compatible wireless devices include such devices as Apple's iPod, Sony's PSP, Creative Technologies' Zen, Microsoft's Zune, and other such devices. The software application allows the bundling of different types of content, such as a full-length movie with its digital counterpart, or a full-length movie with an audio book, or a music cd with a video clip and digital songtracks. Still further combinations are possible. The software application also creates numerous advertising possibilities during the content transfer process for both the content owner as well as third parties desirous of reaching targeted markets. The advertising opportunities offset additional costs of the installation of the software and can easily become a revenue producer for the content owner. The software application gives consumers a greater incentive to purchase the physical cd or dvd because it offers true portability, contains richer content, and is more consumer friendly because it works with such a wide variety of devices on the market.

It is thus believed that the operation and system of the present invention will be apparent from the foregoing description and the Exhibits attached hereto. While the method shown or described has been characterized as being preferred, it will be obvious that various changes and modifications may be made therein without departing from the spirit and scope of the invention.

What is claimed is:

1. A computer readable storage medium, comprising:
a plurality of media files, the plurality of media files comprising a plurality of media file sets, each media file set corresponding to a respective one of a plurality of media items, each media file set comprising media files of different media file formats; and
program instructions, wherein the program instructions are executable to implement an application configured to:
detect one or more available media players;
receive a user selection of a target media player from among the one or more detected media players;
receive a user selection of a media item from among the plurality of media items for transfer to the target media player;
select a media file from among the set of media files corresponding to the user-selected media item based on the media file format associated with the target media player; and
initiate transfer of the selected media file to the target media player.

2. The computer readable storage medium as recited in claim 1, further comprising data representative of audio files that are playable by a compact disc player.

3. The computer readable storage medium as recited in claim 1, further comprising data representative of video files that are playable by a compact disc player.

4. A method comprising:
detecting one or more available media players;
receiving a user selection of a target media player from among the one or more detected media players;
receiving a user selection of a media item from among a plurality of media items for transfer to the target media player;
selecting a media file from among a set of media files corresponding to the user-selected media item based on the media file format associated with the target media player; and
initiating transfer of the selected media file to the target media player.

5. The method as recited in claim 4, further comprising retrieving the selected media file from a removable computer readable storage medium.

6. A system comprising:
one or more processors;
a memory coupled to the one or more processors, wherein the memory is configured to store program instructions executable by the one or more processors to implement an application configured to:
detect one or more available media players;
receive a user selection of a target media player from among the one or more detected media players;
receive a user selection of a media item from among a plurality of media items for transfer to the target media player;
select a media file from among a set of media files corresponding to the user-selected media item based on the media file format associated with the target media player; and
initiate transfer of the selected media file to the target media player.

7. The system as recited in claim 6, further comprising a reader for reading a removable computer readable storage medium.

8. The system as recited in claim 7, wherein the application is further configured to retrieve the selected media file from a removable computer readable storage medium.
